(19) United States
(12) Patent Application Publication
(10) Pub. No.: US 2012/0190390 A1
(43) Pub. Date: Jul. 26, 2012

(54) RADIO COMMUNICATION

(75) Inventors: Jukka Reunamaki, Tampere (FI); Arto Palin, Viiala (FI)

(73) Assignee: NOKIA CORPORATION, Espoo (FI)

(21) Appl. No.: 13/395,115

(22) PCT Filed: Sep. 10, 2009
(86) PCT No.: PCT/FI09/50727

§ 371 Date: Apr. 10, 2012

(30) Foreign Application Priority Data
Sep. 10, 2009 (FI) PCT/FI2009/050727

(51) Int. Cl. H04W 52/02; H04W 4/06

(52) U.S. Cl. 455/500

(57) ABSTRACT

According to an example embodiment, there is provided a method, an apparatus, and a computer program for identifying a first wake-up signal, received from a first apparatus using a first radio device, as a forwarding wake-up signal; and in response to identifying the first wake-up signal as a forwarding wake-up signal, enabling one or more other radio devices, different to the first radio device, to receive a first data signal and forward the first data signal to at least a second apparatus. The first radio device may operate at a lower power than the one or more other radio devices. The first data signal may be received from the first apparatus.

### CROSS-REFERENCE TO RELATED APPLICATIONS

This application is a national stage entry of PCT Application No. PCT/FI2009/050727, filed on Sep. 10, 2009, entitled “RADIO COMMUNICATION,” which is hereby incorporated by reference.

### FIELD OF THE INVENTION

Embodiments of the present invention relate to radio communication. In particular, they relate to distributing information in a radio communication network in a power efficient manner.

### BACKGROUND TO THE INVENTION

A plurality of radio apparatuses may form an ad-hoc radio communication network. In order for a radio apparatus to receive data transmitted to it in the network, the radio apparatus may ‘listen’ continuously for radio signals. However, radio apparatuses that operate in this manner typically consume a lot of power.

In other implementations, each of the radio apparatuses may be synchronized to a common clock. Each radio apparatus may ‘listen’ for radio signals in a window assigned to it. Radio apparatuses that operate in this manner may consume less power than those referred to above. However, in a network including many radio apparatuses, data transfer may be less efficient because of the large amount of time allocated for ‘listening’.

### BRIEF DESCRIPTION OF VARIOUS EMBODIMENTS OF THE INVENTION

According to various, but not necessarily all embodiments of the invention, there is provided a method, comprising: identifying a first wake-up signal, received from a first apparatus using a first radio device, as a forwarding wake-up signal; and in response to identifying the first wake-up signal as a forwarding wake-up signal, enabling one or more other radio devices, different to the first radio device, to receive a first data signal and forward the first data signal to at least a second apparatus.

The first radio device may operate at a lower power than the one or more other radio devices. The first data signal may be received from the first apparatus.

The first wake up signal may be identified as being a forwarding wake-up signal from a plurality of different wake-up signals. At least one wake-up signal from the plurality of different wake-up signals may identify a data distribution method.

The plurality of different wake-up signals may comprise wake-up signals for a group of data distributions methods comprising at least two of: unicast, multicast and broadcast.

Enabling the one or more radio devices may comprise causing the one or more other radio devices to enter an operational state.

The method may further comprise controlling the first radio device to forward the first wake-up signal, wherein the first wake-up signal is forwarded prior to the first data signal being forwarded.

A second radio device, different to the first radio device, may be enabled to receive and forward the first data signal. The second radio device may be configured to operate using a radio communication protocol. The first wake-up signal may indicate that the first data signal is receivable using the radio communication protocol. The second radio device may be enabled after identifying the radio communication protocol from the first wake-up signal.

A second radio device, different to the first radio device, may be enabled to receive the first data signal. A third radio device, different to the first and second radio devices, may be enabled to forward the first data signal to the second apparatus.

The second radio device may be configured to operate using a radio communication protocol. The first wake-up signal may identify a radio communication protocol for receiving the first data signal. The second radio device may be enabled after identifying the radio communication protocol from the first wake-up signal.

The third radio device may be configured to operate using a further radio communication protocol. The third radio device may be enabled after identifying that the at least a second apparatus is compatible with the further radio communication protocol.

The method may further comprise receiving the first data signal. The first wake-up signal and the first data signal may be received at the same location. The method may further comprise forwarding the first data signal to at least the second apparatus.

According to various, but not necessarily all embodiments of the invention, there is provided a computer program comprising computer program instructions that, when executed by at least one processor, enables the method as described above to be performed.

According to various, but not necessarily all embodiments of the invention, there is provided an apparatus, comprising: an interface; and processing circuitry configured to identify a first wake-up signal, received from a first apparatus using a first radio device, as a forwarding wake-up signal, and configured, in response to identifying the first wake-up signal as a forwarding wake-up signal, to use the interface to enable one or more other radio devices, different to the first radio device, to receive a first data signal and forward the first data signal to at least a second apparatus.

The first radio device may be configured to operate at a lower power than the one or more other radio devices. The first data signal may be received from the first apparatus.

The processing circuitry may be configured to identify the first wake up signal as being a forwarding wake-up signal from a plurality of different wake-up signals. At least one wake-up signal from the plurality of different wake-up signals may identify a data distribution method.

The processing circuitry may be configured to control the first radio device to forward the first wake-up signal. The first wake-up signal may be forwarded prior to the first data signal being forwarded.

The processing circuitry may be configured to enable a second radio device, different to the first radio device, to receive and forward the first data signal.

The processing circuitry may be configured to enable a second radio device, different to the first radio device, to receive the first data signal. The processing circuitry may be configured to enable a third radio device, different to the first and second radio devices, to forward the first data signal to the second apparatus.

The apparatus may further comprise the first radio device. The apparatus may further comprise the one or more other radio devices.

According to various, but not necessarily all embodiments of the invention, there is provided a computer program comprising computer program instructions that, when executed by at least one processor, enable: identifying a first wake-up signal, received from a first apparatus using a first radio device, as a forwarding wake-up signal; and in response to identifying the first wake-up signal as a forwarding wake-up signal, enabling a second radio device to receive a first data signal and forward the first data signal to at least a second apparatus.

The first radio device may operate at a lower power than the one or more other radio devices. The first data signal may be received from the first apparatus.

The first wake up signal may be identified as being a forwarding wake-up signal from a plurality of different wake-up signals. At least one wake-up signal from the plurality of different wake-up signals may identify a data distribution method.

A second radio device, different to the first radio device, may be enabled to receive and forward the first data signal.

A second radio device, different to the first radio device, may be enabled to receive the first data signal. A third radio device, different to the first and second radio devices, may be enabled to forward the first data signal to the second apparatus.

According to various, but not necessarily all embodiments of the invention, there is provided a tangible computer-readable medium storing the computer program as described above.

According to various, but not necessarily all embodiments of the invention, there is provided an apparatus, comprising: means for identifying a first wake-up signal, received from a first apparatus by a first radio device, as a forwarding wake-up signal; and means for enabling a second radio device, in response to identifying the first wake-up signal as a forwarding wake-up signal, to receive a first data signal and forward the first data signal to at least a second apparatus.

The first radio device may be configured to operate at a lower power than the one or more other radio devices.

According to various, but not necessarily all embodiments of the invention, there is provided a method, comprising: determining, for a first data signal, a data distribution method from a plurality of different data distribution methods; and in response to determining a first data distribution method from the plurality of different data distribution methods, generating a first wake-up signal for transmission by a radio device; in response to determining a second, different, data distribution method from the plurality of data distribution methods, generating a second, different, wake-up signal for transmission by the radio device.

The first wake-up signal may identify the first data distribution method. The second wake-up signal may identify the second data distribution method. The first and second data distribution methods may be any two from the group: broadcast, multicast and unicast.

The method may further comprise transmitting the first wake-up signal or the second wake-up signal, and subsequently transmitting a first data signal. The transmitted wake-up signal may identify a radio communication protocol for use in receiving the first data signal.

According to various, but not necessarily all embodiments of the invention, there is provided an apparatus, comprising: processing circuitry to determine, for a first data signal, a data distribution method from a plurality of different data distribution methods, wherein the processing circuitry is configured, in response to determining a first data distribution method from the plurality of different data distribution methods, to generate a first wake-up signal for transmission by a radio device, and the processing circuitry is configured, in response to determining a second, different, data distribution method from the plurality of data distribution methods, to generate a second, different, wake-up signal for transmission by the radio device.

The first wake-up signal may identify the first data distribution method. The second wake-up signal may identify the second data distribution method. The first and second data distribution methods may be any two from the group: broadcast, multicast and unicast.

The apparatus may further comprise a first radio device configured to transmit a generated wake-up signal, and a second radio device to transmit a first data signal, subsequent to the transmission of a generated wake-up signal.

The transmitted wake-up signal may identify a radio communication protocol for use in receiving the first data signal.

According to various, but not necessarily all embodiments of the invention, there is provided a computer program comprising computer program instructions that, when executed by at least one processor, enable: determining, for a first data signal, a data distribution method from a plurality of different data distribution methods; and in response to determining a first data distribution method from the plurality of different data distribution methods, generating a first wake-up signal for transmission by a radio device; in response to determining a second, different, data distribution method from the plurality of data distribution methods, generating a second, different, wake-up signal for transmission by the radio device.

The first wake-up signal may identify the first data distribution method, and the second wake-up signal identifies the second data distribution method. The first and second data distribution methods may be any two from the group: broadcast, multicast and unicast.

The computer program instructions may further enable: transmitting the first wake-up signal or the second wake-up signal, and subsequently transmitting a first data signal.

The transmitted wake-up signal may identify a radio communication protocol for use in receiving the first data signal.

According to various, but not necessarily all embodiments of the invention, there is provided a tangible computer-readable medium storing the computer program as described above.

According to various, but not necessarily all embodiments of the invention, there is provided an apparatus, comprising: means for determining, for a first data signal, a data distribution method from a plurality of different data distribution methods; means for generating, in response to determining a first data distribution method from the plurality of different data distribution methods, a first wake-up signal for transmission by a radio device; and means for generating, in response to determining a second, different, data distribution method from the plurality of data distribution methods, a second, different, wake-up signal for transmission by the radio device.

The first wake-up signal may identify the first data distribution method, and the second wake-up signal may identify the second data distribution method.

### BRIEF DESCRIPTION OF THE DRAWINGS

For a better understanding of various examples of embodiments of the present invention reference will now be made by way of example only to the accompanying drawings in which:

FIG. 1 illustrates a schematic of an apparatus;

FIG. 2 illustrates a more detailed schematic of the apparatus of FIG. 1;

FIG. 3 illustrates a first example of a radio communication network;

FIG. 4A illustrates a first method;

FIG. 4B illustrates a second method;

FIG. 5 illustrates a second example of a radio communication network;

FIG. 6 illustrates a first timing diagram for communication of data in a radio communication network;

FIG. 7 illustrates a second timing diagram for communication of data in a radio communication network; and

FIG. 8 illustrates a third timing diagram for communication of data in a radio communication network.

### DETAILED DESCRIPTION

Embodiments of the present invention relate to the communication of data in a radio communication network. A first apparatus may determine, for a first data signal, a data distribution method such as broadcast, multicast or unicast. The first apparatus may generate a wake-up signal for the first data signal that identifies the determined data distribution method. The first apparatus may use a first, low power, wake-up radio device to transmit the generated wake-up signal to a second apparatus. After the generated wake-up signal has been transmitted, the first apparatus may use a second radio device to transmit the first data signal to the second apparatus.

The second apparatus may receive the generated wake-up signal from the first apparatus using a first, low power, wake-up radio device. The second apparatus may identify the determined data distribution method from the received wake-up signal. The second apparatus may determine from the data distribution method that it is to forward the first data signal. The second apparatus may enable one or more radio devices (different to the first, low power, wake-up radio device) to receive and forward the first data signal from the first apparatus.

The Figures illustrate an apparatus 1/9/30 comprising: processing circuitry 12 to determine, for a first data signal 34, a data distribution method from a plurality of different data distribution methods, wherein the processing circuitry 12 is configured, in response to determining a first data distribution method from the plurality of different data distribution methods, to generate a first wake-up signal for transmission by a radio device 10, and the processing circuitry 12 is configured, in response to determining a second, different, data distribution method from the plurality of data distribution methods, to generate a second, different, wake-up signal for transmission by the radio device 10.

The Figures also illustrate an apparatus 2/9/30, comprising: an interface 13; and processing circuitry 12 configured to identify a first wake-up signal 32, received from a first apparatus 1 using a first radio device 10, as a forwarding wake-up signal, and configured, in response to identifying the first wake-up signal 32 as a forwarding wake-up signal, to use the interface 13 to enable one or more other radio devices 20, different to the first radio device 10, to receive a first data signal 34 and forward the first data signal 34 to at least a second apparatus 3.

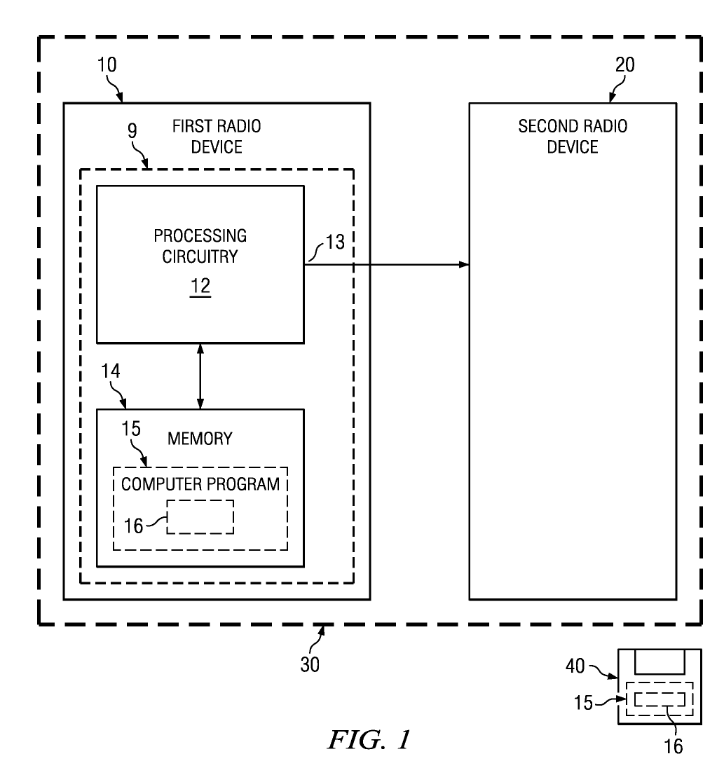

FIG. 1 illustrates an exemplary apparatus 30. The apparatus 30 may be an electronic device, such as a hand-portable electronic device. For example, the apparatus 30 may be a mobile telephone, a personal digital assistant, a personal music player, a notebook or a netbook.

The exemplary apparatus 30 illustrated in FIG. 1 comprises a first radio device 10 and a second radio device 20. In other implementations, further radio devices may also be provided. The first radio device 10 is illustrated as comprising an apparatus 9. The apparatus 9 may, for example, be a chipset. In this example, the apparatus 9 comprises processing circuitry 12, an interface 13 and a memory 14.

The elements 10, 12, 13, 14 and 20 are operationally coupled and any number or combination of intervening elements can exist (including no intervening elements). In the FIG. 1 example, the first and second radio devices 10, 20 are co-located. For instance, they may both be contained within a casing of the apparatus 30.

The first radio device 10 is configured to receive and transmit radio signals using a first radio communication protocol. The first radio communication protocol may, for example, be an IEEE (Institute of Electrical and Electronic Engineers) 802.15.4 protocol. The first radio device 10 may be a ‘wake up’ radio device that consumes a relatively small amount of power when it is in an operational state.

The second radio device 20 is configured to receive and transmit radio signals using a second radio communication protocol. The second radio communication protocol may be different to the first radio communication protocol. The second radio communication protocol may, for example, be a Bluetooth protocol or an IEEE 802.11 protocol.

The first and second radio devices 10, 20 may operate in the same frequency band(s). In some implementations of the invention, some components of the first and second radio devices 10, 20 may be shared. For example, the first and second radio 10, 20 devices may share a common antenna.

The second radio device 20 may have a ‘sleep’ state and an ‘operational’ state. The second radio device 20 may be operable to receive and transmit radio signal when it is in the operational state, but not when it is in the sleep state. When the second radio device 20 is in its operational state, it consumes more power than when it is in its sleep state. In some implementations of the invention, the second radio device 20 consumes no power when it is in the sleep state.

When the second radio device 20 is in its operational state, it consumes more power than the first radio device 20 when the first radio device 10 is in its operational state. The second radio device 20 may also be configured to communicate data at a faster data rate than the first radio device 10.

The first radio device 10 and the second radio device 20 may communicate using long range or short range radio signals. The range of the long range radio signals may, for example, be over 100 metres. In some other implementations of the invention, the range of the short range radio signals may, for example, 100 metres or less. In some further implementations, the range of the short range radio signals may, for example, 10 metres or less.

The processing circuitry 12 is configured to receive input signals and to provide output signals. The processing circuitry 12 is configured to write to and read from the memory 14. The processing circuitry 12 is also configured to use the interface 13 to enable the second radio device 20 to receive and transmit radio signals, by providing an output signal to the second radio device 20 that switches it from being in its ‘sleep’ state to being in its ‘operational’ state.

Implementation of the processing circuitry 12 can be in hardware alone (a circuit, a processor, etc), have certain aspects in software including firmware alone or can be a combination of hardware and software (including firmware). FIG. 1 illustrates an exemplary implementation in which the processing circuitry 12 operates using executable computer program instructions 16 stored in the memory 14.

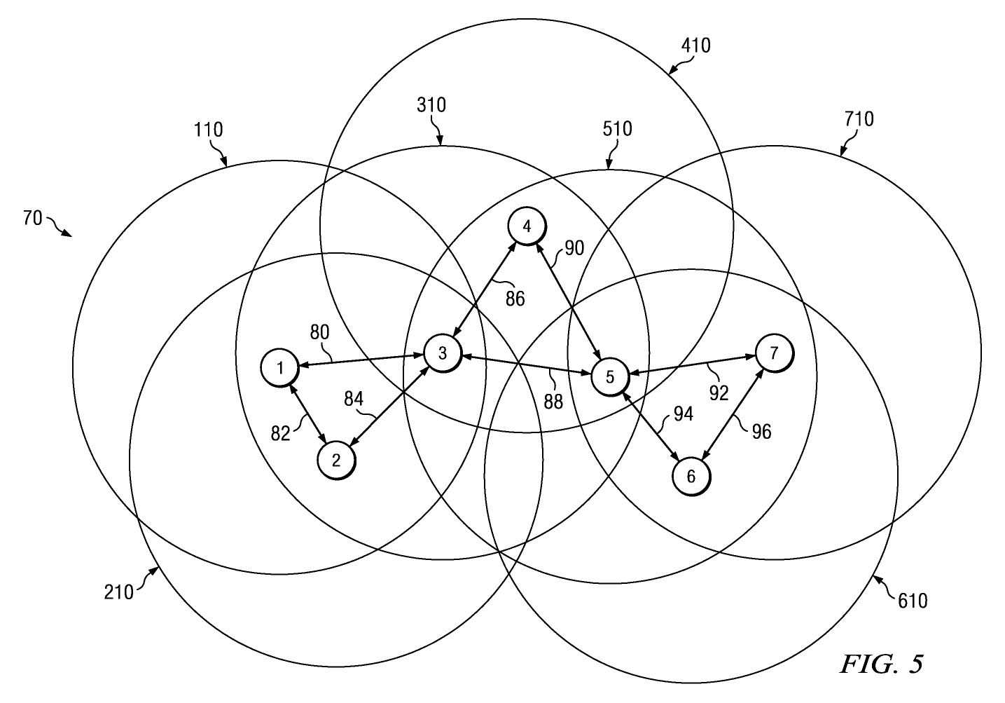

The memory 14 is illustrated as storing a computer program 15 comprising the computer program instructions 16 that control the operation of the apparatus 30 when loaded into the processing circuitry 12. The computer program instructions 16 provide the logic and routines that enables the apparatus 30 to perform at least some aspects of the methods illustrated in FIGS. 4A and 4B and FIGS. 6 to 8.

The computer program 15 may arrive at the apparatus 30 via any suitable delivery mechanism 40. The delivery mechanism 40 may be, for example, a tangible computer-readable storage medium, a computer program product, a memory device, a record medium such as a CD-ROM or DVD, or an article of manufacture that tangibly embodies the computer program 15. The delivery mechanism 40 may be a signal configured to reliably transfer the computer program 15. The apparatus 30 may propagate or transmit the computer program 15 as a computer data signal.

Although the memory 14 is illustrated as a single component it may be implemented as one or more separate components some or all of which may be integrated/removable and/or may provide permanent/semi-permanent/dynamic/cached storage.

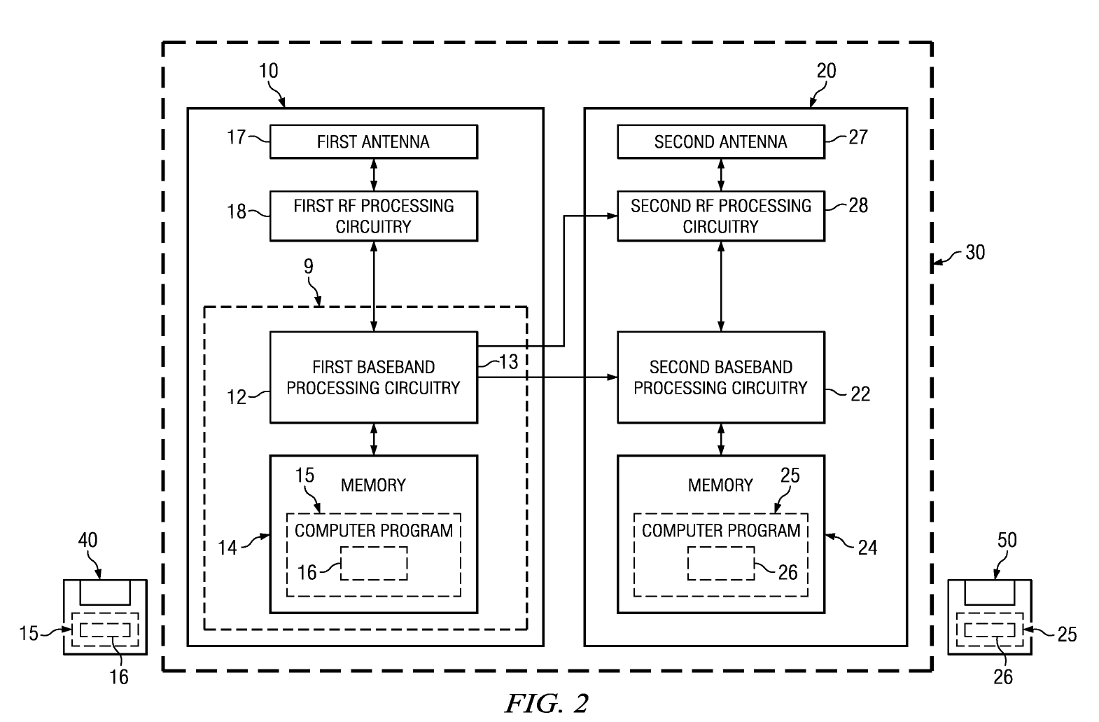

FIG. 2 illustrates an example of a more detailed schematic of the apparatus 30 of FIG. 1. The radio device 10 illustrated in FIG. 2 comprises a first antenna 17, first radio frequency (RF) processing circuitry 18, first baseband processing circuitry 12, an interface 13 and a memory 14. The first baseband processing circuitry 12, the interface 13 and the memory 14 illustrated in FIG. 1 correspond with the similarly numbered elements illustrated in FIG. 1.

The first antenna 17 is configured to receive and transmit radio signals. The first RF processing circuitry 18 is configured to modulate and up-convert signals (from the first baseband processing circuitry 12) for transmission as radio signals complying with the first radio communication protocol. The first RF processing circuitry 18 is also configured to demodulate and down-convert radio signals complying with the first radio communication protocol, and provide the resulting information to the first baseband processing circuitry 12.

The second radio device comprises a second antenna 27, second RF processing circuitry 28, second baseband processing circuitry 22 and a second memory 24.

The second antenna 27 is configured to receive and transmit radio signals. The second RF processing circuitry 28 is configured to modulate and up-convert signals (from the second baseband processing circuitry 22) for transmission as radio signals complying with the second radio communication protocol. The second RF processing circuitry 28 is also configured to demodulate and down-convert radio signals complying with the second radio communication protocol, and to provide the resulting information to the second baseband processing circuitry 22.

The second baseband processing circuitry 22 is configured to receive input signals and to provide output signals. The second baseband processing circuitry 22 is configured to write to and read from the memory 24. Implementation of the second baseband processing circuitry 22 can be in hardware alone (a circuit, a processor, etc), have certain aspects in software including firmware alone or can be a combination of hardware and software (including firmware). FIG. 2 illustrates an exemplary implementation in which the second baseband processing circuitry 22 operates using executable computer program instructions 26 stored in the memory 24.

The memory 24 is illustrated as storing a computer program 25 comprising the computer program instructions 26 that control the operation of the apparatus 30 when loaded into the second baseband processing circuitry 22.

The computer program 25 may arrive at the apparatus 30 via any suitable delivery mechanism 50. The delivery mechanism 50 may be, for example, a tangible computer-readable storage medium, a computer program product, a memory device, a record medium such as a CD-ROM or DVD, or an article of manufacture that tangibly embodies the computer program 25. The delivery mechanism 50 may be a signal configured to reliably transfer the computer program 25. The apparatus 30 may propagate or transmit the computer program 25 as a computer data signal.

Although the memory 24 is illustrated as a single component it may be implemented as one or more separate components some or all of which may be integrated/removable and/or may provide permanent/semi-permanent/dynamic/cached storage.

In some implementations of the invention, the first baseband processing circuitry 12 is configured to provide a control signal to the second baseband processing circuitry 22 to switch the second radio device 20 from being in its sleep mode to being in its operational mode.

Alternatively, the first baseband processing circuitry 12 may be configured to provide a control signal to the second RF processing circuitry 28 to switch the second radio device 20 from being in its sleep mode to being in its operational state. In this implementation, the second RF processing circuitry 28 may enter its operational state, without the second baseband processing circuitry 22 entering its operational state. This is explained in further detail below.

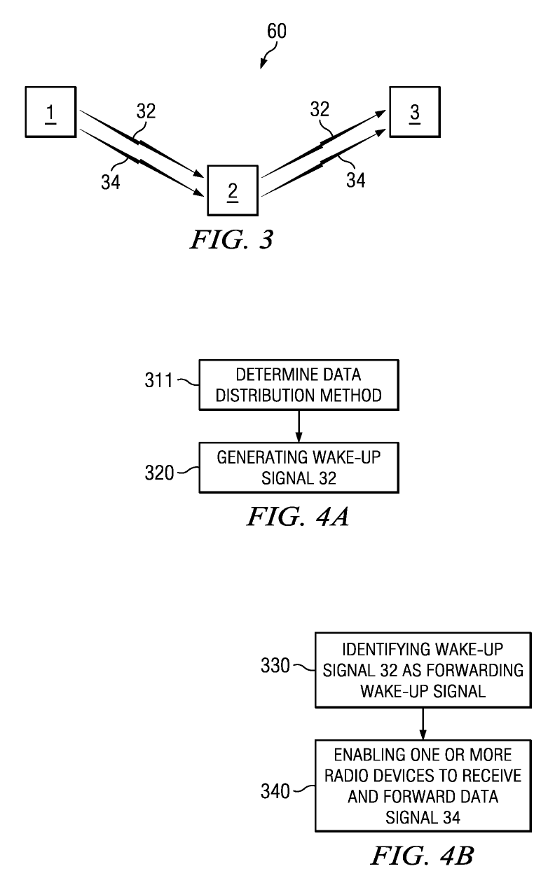

A method according to embodiments of the invention will now be described in relation to FIGS. 3, 4A and 4B.

FIG. 3 illustrates a radio communication network 60 comprising first, second and third apparatuses 1, 2, 3. Each of the apparatuses 1, 2, 3 may take the same form as the apparatus 30 illustrated in FIG. 2. The radio communication network 60 may, for example, be an ad-hoc network.

In the FIG. 3 example, the transmission ranges of the first and third apparatuses 1, 3 are such that they cannot communicate directly with one another. The second apparatus 2 is able to communicate directly with both the first apparatus 1 and the third apparatus 3.

Consider an example in which the first apparatus 1 wishes to communicate first information in the network 60. The first apparatus 1 can communicate the first information according one of a number of data distribution methods. The data distribution methods include: unicast, multicast and broadcast.

Unicast involves the transmission of information to (only) a single apparatus in a network. Multicast involves the transmission of information to a sub-set of apparatuses in a network. Broadcast involves the transmission of information to all of the apparatuses in a network.

At block 311 of FIG. 4A, the first apparatus 1 determines a data distribution method for the first information. In the following example, the first information is to be broadcast in the network 60.

At block 320 of FIG. 4A, the first baseband processing circuitry 12 of the first apparatus 1 generates a first wake-up signal 32 for the first information. The first wake-up signal 32 does not include the first information. Following up-conversion and modulation by the first RF processing circuitry 18, the first wake-up signal 32 is transmitted by the first radio device 10 of the first apparatus 1. A first data signal 34, including the first information, is subsequently transmitted by the second radio device 20 of the first apparatus 1.

The first wake-up signal 32 includes a distribution type identifier that identifies the data distribution method for the first data signal 34, which in this case is broadcast. The first wake-up signal 32 also includes a message identifier, which uniquely identifies the broadcast. The message identifier in this example may, for example, be a random number generated by the first baseband processing circuitry 12.

The first wake-up signal 32 may also include other information, such as an indication of the radio communication protocol that will be used to transmit the first data signal 34 and an indication of the time at which the first data signal 34 will be transmitted, relative to the transmission of the first wake-up signal 32.

The first radio device 10 of the second apparatus 2 receives the first wake-up signal 32 from the first apparatus 1. At block 330 of FIG. 4B, the first baseband processing circuitry 12 of the second apparatus 2 processes the wake-up signal 32, following down-conversion and demodulation by the first RF processing circuitry 18.

The first baseband processing circuitry 12 of the second apparatus 2 identifies, from the distribution type identifier, the first wake-up signal 32 as a forwarding wake-up signal. That is, the baseband processing circuitry 12 identifies that the first apparatus 1 is about to transmit a data signal 34 which should be forwarded by the second apparatus 2.

At block 340 of FIG. 4B, in response to identifying the first wake-up signal 32 as a forwarding wake-up signal, the first baseband processing circuitry 12 (of the second apparatus 2) uses the interface 13 to enable the second radio device 20 (of the second apparatus 2) to receive and forward the first data signal 34.

In more detail, the first baseband processing circuitry 12 of the second apparatus 2 uses the interface 13 to output a control signal to the second baseband processing circuitry 22 of the second radio device 20. The control signal causes the second radio device 20 to switch from being its sleep state to being in its operational state.

When the second radio device 20 of the second apparatus 2 is in its operational state, it receives the first data signal 34 from the first apparatus 1. The second RF processing circuitry 28 of the second radio device 20 down-converts and demodulates the first data signal 34.

The second RF processing circuitry 28 provides the first data signal 34 to the second baseband processing circuitry 22, which processes the first information included in the first data signal 34. The second baseband processing circuitry 22 may, for example, communicate the first information to a central processor of the second apparatus 2 (not shown).

The second baseband processing circuitry 22 of the second apparatus 2 also controls the second RF processing circuitry 28 to forward (re-transmit) the first data signal 34.

Prior to the first data signal 34 being forwarded by the second apparatus 2, the first radio device 10 of second apparatus 2 forwards the first wake-up signal 32. In this example, the first wake-up signal 34 is forwarded using the first radio communication protocol. However, in other implementations, the first wake-up signal 32 may be forwarded using an alternative radio communication protocol. The radio communication protocol may, for example, depend upon the reception capabilities of the apparatus that is to receive the forwarded first wake-up signal 32.

After the first wake-up signal 32 and the first data signal 34 have been forwarded by the second apparatus 2, the first baseband processing circuitry 12 (of the second apparatus 2) may output a control signal to the second baseband processing circuitry 22 (of the second apparatus 2). The control signal may disable the second radio device 20. For example, the control signal may cause the second radio device 20 to switch from being its operational state to being in its sleep state.

The first wake-up signal 32 transmitted by the second apparatus 2 is received by the first radio device 10 of the third apparatus 3. The first radio device 10 of the third apparatus 3 then causes the second radio device 20 of the third apparatus 3 to switch from being in its sleep state to being in its operational state. The second radio device 20 of the third apparatus 3 may then receive and forward the first data signal 34 transmitted by the second apparatus 2.

Prior to forwarding the first data signal 34, the third apparatus 3 re-transmits the wake-up signal 32 using its first radio device 10. The re-transmission of the first wake-up signal 32 may be received by the second apparatus 2. In this eventuality, the first baseband processing circuitry 12 of the second apparatus 2 determines, from the message identifier included in the first wake-up signal 32, that the first apparatus 1 has already received and forwarded the first data signal 34. Consequently, the second apparatus 2 may ignore the first data signal 34 transmitted by the third apparatus 3.

Embodiments of the invention have been described above in relation to a broadcast. However, as mentioned above, other data distribution methods are possible, such as unicast or multicast.

A wake-up signal for a unicast data signal transmission may include a distribution type identifier that identifies a data signal transmission as a unicast transmission. The wake-up signal may also include a message identifier that identifies an address of the apparatus to which the data signal transmission is being made.

In the case of a unicast transmission, if an apparatus different to that identified in the message identifier receives the wake-up signal, the second radio device 20 of the apparatus might not be enabled and the apparatus may ignore the subsequently transmitted data signal.

A wake-up signal for a multicast data signal transmission may include a distribution type identifier that identifies a data signal transmission as a multicast transmission. The wake-up signal may also include a message identifier that identifies a group address for the apparatuses to which the data signal transmission is being made.

If an apparatus determines, from the group address identified in the wake-up signal, that the multicast data signal transmission is not relevant to it, the second radio device 20 of that apparatus may not be enabled and the apparatus may ignore the subsequently transmitted data signal.

Embodiments of the invention advantageously provide a power-efficient way of propagating information through a network. The use of wake-up signals in the network means that a high data rate, high power (second) radio device need only be in an operational state when it is in use. Also, the use of different types of wake-up signal advantageously enables an apparatus to determine whether to receive and forward a subsequently transmitted data signal.

FIG. 5 illustrates a radio communication network 70 including seven apparatuses, 1-7. The apparatuses illustrated in FIG. 5 take the same form as the apparatus described above in relation to FIG. 2. The transmission ranges of the first to seventh apparatuses 1-7 are indicated by the reference numerals 110, 210, 310, 410, 510, 610 and 710 respectively.

The arrows 80, 82, 84, 86, 88, 90, 92, 94 and 96 indicate possibilities for direct communication in the network 70. For example, arrows 80 and 82 indicate that the first apparatus 1 may communicate directly with the second and third apparatuses 2, 3. The other apparatuses 4-7 are outside the transmission range of the first apparatus 1.

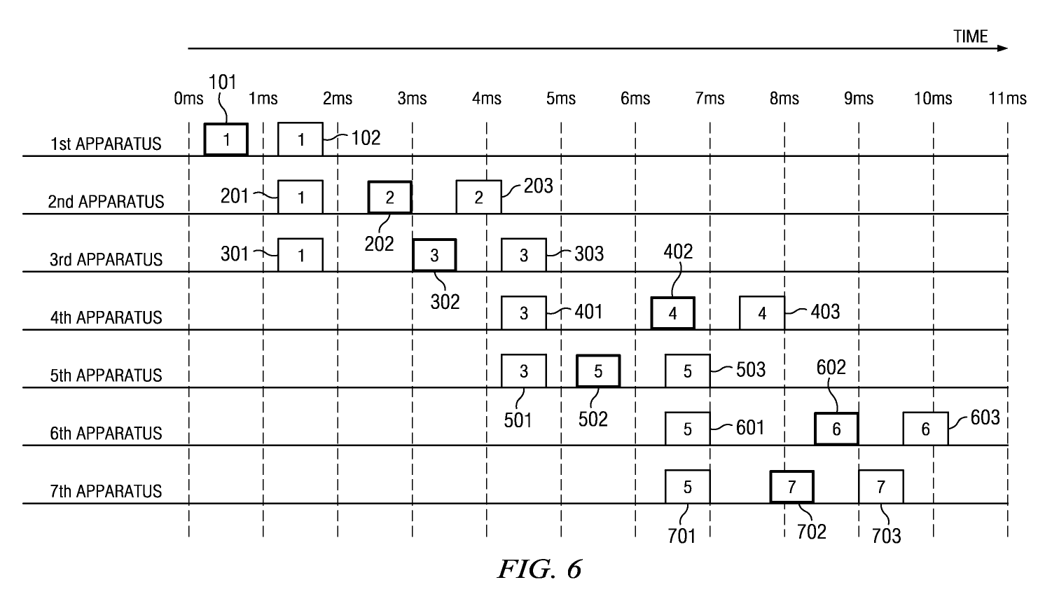

FIG. 6 is an exemplary timing diagram that illustrates a first wake-up signal and a first data signal being propagated through the network 70 by the apparatuses 1-7.

Block 101 represents the transmission of a first wake-up signal by the first radio device 10 of the first apparatus 1, which is subsequently received by the first radio devices 10 of the second and third apparatuses 2, 3. In response to receiving the first wake-up signal, the second radio devices 20 of the second and third apparatuses 2, 3 are enabled.

Block 102 represents the transmission of a first data signal by the second radio device 20 of the first apparatus 1. Blocks 201 and 301 indicate the first data signal being received by the second radio devices 20 of the second and third apparatuses 2, 3 respectively.

Block 202 represents the first wake-up signal being forwarded by the second apparatus 2. The first wake-up signal transmitted by the second apparatus 2 is received by the first and third apparatuses 1, 3. The first and third apparatuses 1, 3 recognize this as being a re-transmission of the first wake-up signal transmitted by the first apparatus 1 (from the message identifier of the first wake up signal). Consequently, when the first data signal is re-transmitted by the second radio device 20 of the second apparatus 2 at block 203, it is not received and processed by the first and third apparatuses 1, 3.

In the example, the first radio device 10 of the third apparatus 3 utilizes CSMA (carrier sense, multiple access). When the first wake-up signal is re-transmitted by the second apparatus 2 at block 202, the first radio device 10 of the third apparatus 3 senses this re-transmission and waits for the transmission to end before re-transmitting the first wake-up signal itself.

Block 302 represents the re-transmission of the first wake-up signal by the first radio device 10 of the third apparatus 3. This is received by the first radio devices 10 of the fourth and fifth apparatuses 4, 5 which consequently enable their second radio devices 20.

Block 303 indicates the re-transmission of the first data signal by the third apparatus 3. Blocks 401 and 501 indicate the first data signal, transmitted by the third apparatus 3, being received by the second radio devices 20 of the fourth and fifth apparatuses 4, 5.

The first wake-up signal is re-transmitted by the first radio device 20 of the fifth apparatus 5 at block 502. The first radio device 10 of the fourth apparatus 4, utilizing CSMA, senses the re-transmission of the first wake-up signal by the fifth apparatus 5 and waits for it to end, before re-transmitting the first wake-up signal itself at block 402.

The first wake-up signal transmitted by the fourth apparatus 4 is received by the third and fifth apparatuses 3, 5, which recognize it (from the message identifier) as being a copy of a previous transmission.

The first wake-up signal transmitted by the fifth apparatus 5 is received by the first radio devices 10 of the sixth and seven apparatuses 6, 7. In response to receiving the first wake-up signal, the second radio devices 20 of the sixth and seventh apparatuses 6, 7 are enabled.

The first radio devices 10 of the fourth and fifth apparatuses re-transmit the first data signal at blocks 403 and 503 respectively. The re-transmission of the first data signal by the fifth apparatus 5 is received by the sixth and seven apparatuses 6, 7 at blocks 601 and 701. Blocks 602 and 603 illustrate re-transmission of the first wake-up signal and the first data signal respectively by the sixth apparatus 6. Blocks 702 and 703 illustrate re-transmission of the first wake-up signal and the first data signal by the seventh apparatus 7.

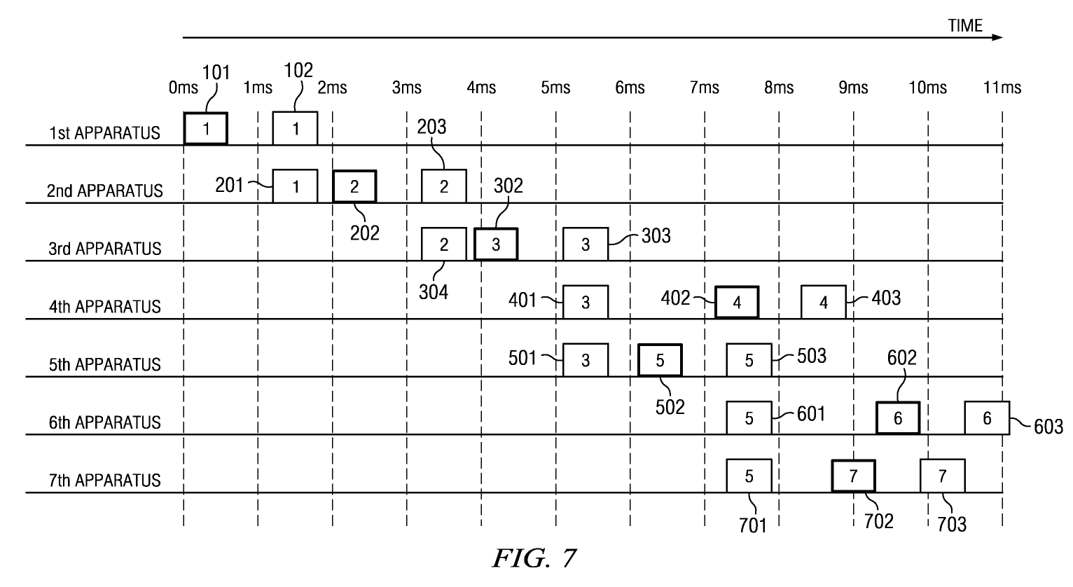

FIG. 7 is a second exemplary timing diagram that illustrates a first wake-up signal and a first data signal being propagated through the network 70 by the apparatuses 1-7. In the FIG. 7 example, the third apparatus 3 fails to receive the first data signal transmitted by the first apparatus 1. Consequently, block 301 (present in FIG. 6) is absent from FIG. 7.

In the FIG. 7 example, the second radio device 20 of the third apparatus 3 may be enabled in response to reception of the first wake-up signal transmitted by the first apparatus 1 (at block 101) or the second apparatus (at block 202).

After the second radio device 20 of the third apparatus 3 is enabled, it receives the first data signal from the second apparatus 2 at block 304.

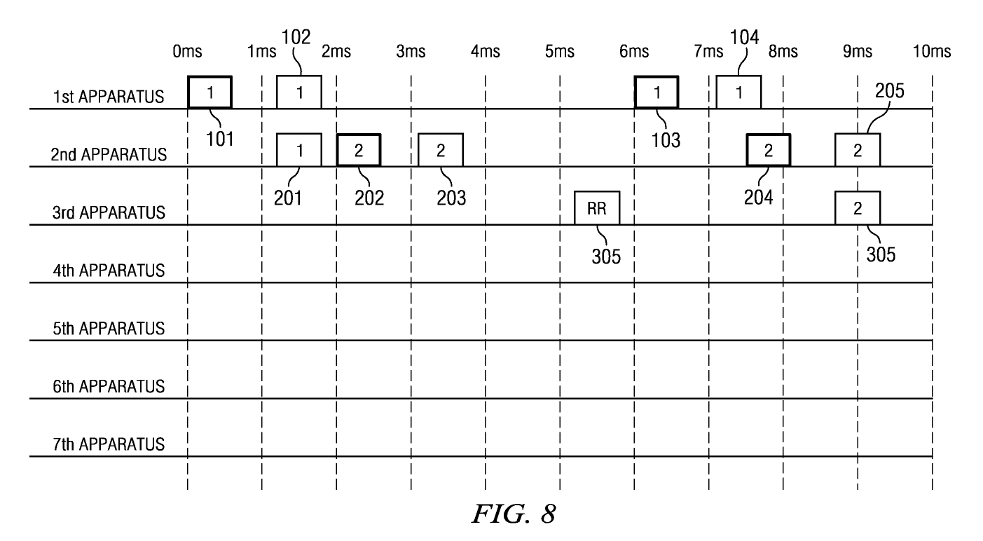

FIG. 8 illustrates a third exemplary timing diagram for information transmitted in the network 70 of FIG. 5. In the FIG. 8 example, the third apparatus 3 initially fails to receive the first data signal from either the first apparatus 1 or the second apparatus 2. Consequently, block 301 (present in FIG. 6) and block 304 (present in FIG. 7) are absent from FIG. 8.

In the FIG. 8 example, the second radio device 20 is enabled in response to reception of the first wake-up signal transmitted by the first apparatus 1 (at block 101) or the second apparatus (at block 202).

After the second radio device 20 has been enabled, the apparatus 1 expects the second radio device 20 to receive a data signal. After a predetermined time has elapsed (following enablement of the second radio device 20) without a data signal being received, the third apparatus 3 transmits a request to resend the data signal at block 305. The request to resend may be transmitted using the first or second radio device 10, 20 of the third apparatus 3.

In the FIG. 8 example, the first and second apparatuses 1, 2 resend both the first wake-up signal (at blocks 103 and 204) and the first data signal (at blocks 104 and 205) after receiving the request to resend from the third apparatus 3. The second radio device 20 of the third apparatus 3 then receives the first data signal from the second apparatus 2 at block 305.

In other implementations of the invention, first and second apparatuses 1, 2 don't resend both the wake-up signal and the first data signal in response to receiving the a request to resend. Instead, the first and second apparatuses 1, 2 only resend the first data signal.

The blocks illustrated in FIGS. 4A, 4B and 6 to 8 may represent steps in a method and/or sections of code in the computer program 15, 25. The illustration of a particular order to the blocks does not necessarily imply that there is a required or preferred order for the blocks and the order and arrangement of the block may be varied. Furthermore, it may be possible for some steps to be omitted.

References to ‘computer-readable storage medium’, ‘computer program product’, ‘tangibly embodied computer program’ etc. or ‘processing circuitry’, ‘computer’, ‘processor’ etc. should be understood to encompass not only computers having different architectures such as single/multi-processor architectures and sequential (Von Neumann)/parallel architectures but also specialized circuits such as field-programmable gate arrays (FPGA), application specific circuits (ASIC), signal processing devices and other devices. References to computer program, instructions, code etc. should be understood to encompass software for a programmable processor or firmware such as, for example, the programmable content of a hardware device whether instructions for a processor, or configuration settings for a fixed-function device, gate array or programmable logic device etc.

Although embodiments of the present invention have been described in the preceding paragraphs with reference to various examples, it should be appreciated that modifications to the examples given can be made without departing from the scope of the invention as claimed. For example, the apparatus 9, comprising the first and baseband processing circuitry 12 and the memory 14 may be located outside the first radio device 10. The second baseband circuitry 22 and the memory 24 may be located outside the second radio device 20.

In the description above, the first baseband processor 12 is used to identify the first wake-up signal 32 as being a forwarding wake-up signal from the distribution type identifier of the first wake-up signal 32. In other implementations, the first wake-up signal 32 may be identified as being a forwarding wake-up signal by the first RF processing circuitry 18 (for example, by using a correlation technique).

The apparatuses described above comprise two radio devices 10, 20. In some implementations of the invention, apparatuses may comprise three or more radio devices. A wake-up signal transmitted by an apparatus may identify a radio communication protocol the apparatus will use to subsequently transmit a data signal. The first baseband processing circuitry 12 may use that indication to determine which radio device to enable in order to receive the data signal.

In some implementations of the invention, the radio device that is used by an apparatus to receive a data signal may not be the same radio device that is used to forward that data signal. The first baseband processing circuitry 12 may, therefore, enable more than one radio device after a wake-up signal has been received.

The radio device that is selected to (re)send a data signal may depend upon the capabilities of another apparatus. For example, a first apparatus may identify that a second apparatus is compatible with a particular radio communication protocol, prior to (re)sending the data signal to the second apparatus using that radio communication protocol.

Features described in the preceding description may be used in combinations other than the combinations explicitly described.

Although functions have been described with reference to certain features, those functions may be performable by other features whether described or not.

Although features have been described with reference to certain embodiments, those features may also be present in other embodiments whether described or not.

Whilst endeavoring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1-56. (canceled)

57. A method, comprising:
identifying a first wake-up signal, received from a first apparatus using a first radio device, as a forwarding wake-up signal; and
in response to identifying the first wake-up signal as a forwarding wake-up signal, enabling one or more other radio devices, different to the first radio device, to receive a first data signal and forward the first data signal to at least a second apparatus.

58. A method as claimed in claim 57, wherein the first radio device operates at a lower power than the one or more other radio devices.

59. A method as claimed in claim 57, wherein the first data signal is received from the first apparatus.

60. A method as claimed in claim 57, wherein the first wake up signal is identified as being a forwarding wake-up signal from a plurality of different wake-up signals.

61. A method as claimed in claim 60, wherein at least one wake-up signal from the plurality of different wake-up signals identifies a data distribution method.

62. A method as claimed in claim 61, wherein the plurality of different wake-up signals comprises wake-up signals for a group of data distributions methods comprising at least two of: unicast, multicast and broadcast.

63. A method as claimed in claim 57, wherein enabling the one or more radio devices comprises causing the one or more other radio devices to enter an operational state.

64. A method as claimed in claim 57, further comprising controlling the first radio device to forward the first wake-up signal, wherein the first wake-up signal is forwarded prior to the first data signal being forwarded.

65. A method as claimed in claim 57, wherein a second radio device, different to the first radio device, is enabled to receive and forward the first data signal.

66. A method as claimed in claim 65, wherein the second radio device is configured to operate using a radio communication protocol, the first wake-up signal indicates that the first data signal is receivable using the radio communication protocol, and the second radio device is enabled after identifying the radio communication protocol from the first wake-up signal.

67. A method as claimed in claim 57, wherein a second radio device, different to the first radio device, is enabled to receive the first data signal, and wherein a third radio device, different to the first and second radio devices, is enabled to forward the first data signal to the second apparatus.

68. A method as claimed in claim 57, further comprising receiving the first data signal.

69. A method as claimed in claim 57, wherein the first wake-up signal and the first data signal are received at the same location.

70. A method as claimed in claim 57, further comprising forwarding the first data signal to at least the second apparatus.

71. An apparatus, comprising:
an interface; and
processing circuitry configured to identify a first wake-up signal, received from a first apparatus using a first radio device, as a forwarding wake-up signal, and configured, in response to identifying the first wake-up signal as a forwarding wake-up signal, to use the interface to enable one or more other radio devices, different to the first radio device, to receive a first data signal and forward the first data signal to at least a second apparatus.

72. An apparatus as claimed in claim 71, wherein the first radio device is configured to operate at a lower power than the one or more other radio devices.

73. An apparatus as claimed in claim 71, wherein the first data signal is received from the first apparatus.

74. An apparatus as claimed in claim 71, wherein the processing circuitry is configured to identify the first wake up signal as being a forwarding wake-up signal from a plurality of different wake-up signals.

75. An apparatus as claimed in claim 74, wherein at least one wake-up signal from the plurality of different wake-up signals identifies a data distribution method.

76. An apparatus as claimed in claim 71, wherein the processing circuitry is configured to control the first radio device to forward the first wake-up signal, and wherein the first wake-up signal is forwarded prior to the first data signal being forwarded.

77. An apparatus as claimed in claim 71, wherein the processing circuitry is configured to enable a second radio device, different to the first radio device, to receive and forward the first data signal.

78. An apparatus as claimed in claim 71, wherein the processing circuitry is configured to enable a second radio device, different to the first radio device, to receive the first data signal, and the processing circuitry is configured to enable a third radio device, different to the first and second radio devices, to forward the first data signal to the second apparatus.

79. An apparatus as claimed in claim 71, further comprising the first radio device and
the one or more other radio devices.
